(19) United States
(12) Patent Application Publication
(10) Pub. No.: US 2011/0262824 A1
(43) Pub. Date: Oct. 27, 2011

(54) APPARATUS FOR A 12V HYBRID FUEL CELL VEHICLE

(75) Inventors: Sebastian Lienkamp, Budenheim (DE); Oliver Maier, Worms (DE)

(73) Assignee: GM GLOBAL TECHNOLOGY OPERATIONS, INC., Detroit, MI (US)

(21) Appl. No.: 12/766,412

(22) Filed: Apr. 23, 2010

(51) Int. Cl. H01M 8/24

(52) U.S. Cl. 429/452

(57) ABSTRACT

A fuel cell system that does not include a high voltage battery in combination with a fuel cell stack. The fuel cell stack and a bi-directional power module are electrically coupled to a high voltage bus. A first larger capacity 12 volt battery is electrically coupled to the power module opposite to the high voltage bus and a second smaller capacity 12 volt battery is electrically coupled to the first 12 volt battery, where a diode is electrically coupled between the first and second 12 volt batteries and only allows current flow from the first 12 volt battery to the second 12 volt battery. 12 volt battery loads are electrically coupled to the second 12 volt battery.

### BACKGROUND OF THE INVENTION

1. Field of the Invention

This invention relates generally to a fuel cell system that does not employ a high voltage power source, such as a battery, in addition to a fuel cell stack and, more particularly, to a fuel cell system for a vehicle that does not employ a high voltage power source, such as a battery, in addition to a fuel cell stack, but employs a large capacity 12 volt battery and a small capacity 12 volt battery in combination with the fuel cell stack.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte there between. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

Most fuel cell vehicles are hybrid vehicles that employ a rechargeable supplemental high voltage power source in addition to the fuel cell stack, such as a DC battery or an ultracapacitor. The power source provides supplemental power for the various vehicle auxiliary loads, for system start-up and during high power demands when the fuel cell stack is unable to provide the desired power. More particularly, the fuel cell stack provides power to a traction motor and other vehicle systems through a DC voltage bus line for vehicle operation. The battery provides the supplemental power to the voltage bus line during those times when additional power is needed beyond what the stack can provide, such as during heavy acceleration. For example, the fuel cell stack may provide 70 kW of power. However, vehicle acceleration may require 100 kW or more of power. The fuel cell stack is used to recharge the battery at those times when the fuel cell stack is able to meet the system power demand. The generator power available from the traction motor can provide regenerative braking that can also be used to recharge the battery through the DC bus line.

In some fuel cell system designs that employ a high voltage battery, the high voltage components, including the electric traction motor, are electrically coupled to the high voltage bus. The high voltage bus is directly connected to the battery and operates off of the battery voltage, where a DC/DC fuel cell boost circuit is provided between the fuel cell stack and the high voltage bus to allow the fuel cell stack voltage to vary independently of the DC bus voltage. Alternately, the high voltage components of the system are electrically coupled to a high voltage bus that is directly coupled to the fuel cell stack so that the components operate off the stack voltage, where a DC/DC boost circuit is provided between the high voltage bus and the battery to allow the battery voltage to vary independently of the bus voltage.

### SUMMARY OF THE INVENTION

In accordance with the teachings of the present invention, a fuel cell system is disclosed that does not include a high voltage battery in combination with a fuel cell stack. The fuel cell stack and a bi-directional power module are electrically coupled to a high voltage bus. A first larger capacity 12 volt battery is electrically coupled to the power module opposite to the high voltage bus and a second smaller capacity 12 volt battery is electrically coupled to the first 12 volt battery, where a diode is electrically coupled between the first and second 12 volt batteries and only allows current flow from the first 12 volt battery to the second 12 volt battery. 12 volt battery loads are electrically coupled to the second 12 volt battery.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system including a fuel cell stack and a high voltage battery electrically coupled to a high voltage bus; and

FIG. 2 is a schematic block diagram of a fuel cell system that does not include a high voltage battery in combination with a fuel cell stack, but includes two 12 volt batteries.

### DETAILED DESCRIPTION OF THE EMBODIMENTS

The following discussion of the embodiments of the invention directed to a fuel cell system for a vehicle that does not include a high voltage supplemental power source, such as a battery, in addition to a fuel cell stack, but includes two 12 volt batteries, is merely exemplary in nature, and is in no way intended to limit the invention or its applications or uses.

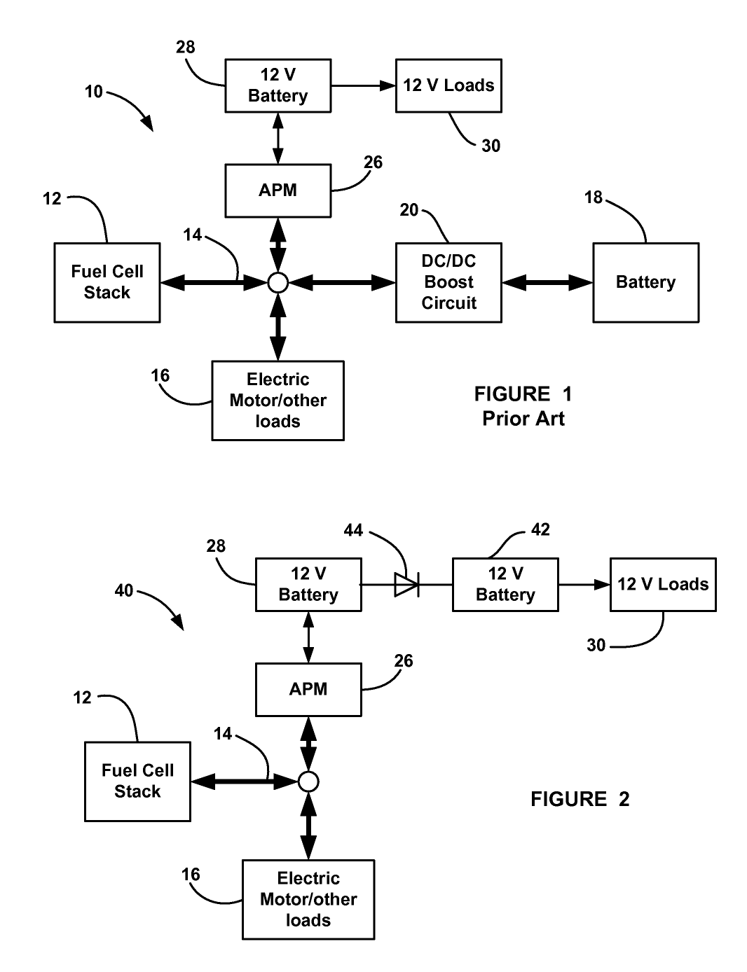

FIG. 1 is a schematic block diagram of a fuel cell system 10 including a fuel cell stack 12. The fuel cell stack 12 is electrically coupled to a high voltage bus 14 that provides power to drive various electrical loads. In this example, the electric traction motor and other high voltage loads 16 are directly coupled to the high voltage bus 14. Thus, the electrical loads 16 draw power from the bus 14 where the voltage on the bus 14 is determined by the output voltage of the fuel cell stack 12. The fuel cell system 10 includes a high voltage battery 18 also electrically coupled to the high voltage bus 14 through a DC/DC boost circuit 20. Because the battery 18 and the fuel cell stack 12 have different output voltages, the charge/discharge power of the battery 18 needs to be transferred to the output voltage level of the fuel cell stack 12, which is provided by the DC/DC boost circuit 20 in a manner that is well understood to those skilled in the art. In an alternate embodiment, the electrical loads 16 can operate at the output voltage of the battery 18, where the DC/DC boost circuit 20 would be provided at the output of the fuel cell stack 12, and transfer the output power of the stack 12 to the high voltage bus 14, also in a manner well understood to those skilled in the art. As discussed above, the battery 18 can supplement the output power of the fuel cell stack 12 for heavy acceleration and other situations where supplemental power is desired. Further, the electric traction motor that is part of the loads 16 can provide power to recharge the battery 18 during regenerative braking.

The fuel cell system 10 also includes an accessory power module (APM) 26 electrically coupled to the high voltage bus 14, which also operates as a voltage conversion device. A 12 volt battery 28 is electrically coupled to the APM 26, where the APM 26 reduces the voltage from the high voltage bus 14 to recharge the battery 28. The battery 28 drives auxiliary low power loads in the vehicle, such as lights, climate control devices, radio, etc., represented here as 12 volt loads 30. In addition, the APM 26 can step up the low voltage from the battery 28 and provide power to the bus 14 during certain vehicle operating conditions, such as at system start-up.

Having the supplemental high voltage source, particularly the battery 18, in the fuel cell system 10 offers a number of advantages for providing that supplemental power. However, the battery 18 is heavy, costly, complex, requires a large and crash-protected volume in the vehicle, etc. Further, temperature has a significant impact on the performance of the battery 18, where low temperatures cause the battery 18 to have a low power output. Further, modern batteries, such as lithium-ion batteries, have high performance, but are typically less robust than lower performing batteries, such as lead/acid batteries, and as such require significant supervisory control to monitor battery state-of-charge, temperature, etc., to maintain performance. Further, because of the temperature dependency of these types of batteries, the battery needs to be cooled during normal operation and high power flow, and heated during low temperature start-ups, thus requiring significant cooling capabilities, temperature sensing, flow control, etc. Thus, even though these types of modern batteries provide significant increases in performance, the monitoring and control required to operate the battery at its optimal point for that performance is also significant.

The markets for vehicles are often different in different areas. For example, some vehicle markets may require high performance where fast acceleration is important, but vehicle top speed may be less important. In other markets, high performance for fast acceleration may not be important, but vehicle top speed is important. The battery 18 could provide the high acceleration performance for those markets that required such performance, but a smaller fuel cell stack may be desirable because top vehicle speed is less important. For those markets that may not require fast acceleration, a large fuel cell stack may be desirable for top speed, but the battery 18 may not be necessary for fast acceleration.

Further, for those situations where heavy braking is provided, it may be desirable to provide a high voltage battery that is able to accept large quantities of regenerative braking power for battery charging purposes. However, statistically such instances of heavy regenerative braking are relatively rare. In addition, the potential loss in drive cycle efficiency due to not being able to capture high amounts of energy during regenerative braking is compensated by the reduced vehicle weight during acceleration.

Therefore, various design considerations go into determining the power source requirements for a fuel cell vehicle. For certain types of fuel cell vehicles, it may be possible, and thus desirable, to eliminate the battery 18 and the DC/DC boost circuit 20 and still provide reliable and desirable vehicle operation. According to the invention, a fuel cell system 40 is shown in FIG. 2, where like elements to the system 10 are identified by the same reference numeral, and where the battery 18 and the boost circuit 20 have been eliminated. In the system 40, the battery 28 can be an inexpensive and robust lead/acid 12 volt battery and still meet the performance requirement of the system 40. The APM 26 would provide the bi-directional down-conversion of power between the high voltage bus 14 and the battery 28 as is well understood to those skilled in the art. Additionally, a smaller capacity 12 volt battery 42 can be provided that is electrically coupled to the larger capacity 12 volt battery 28, and provide power to the loads 30. In this manner, the voltage of the battery 28 that may be drawn down by providing power through the APM 26 to the high voltage bus 14 can be buffered from the loads 30 where lights and so forth on the vehicle will not dim in response to power being drawn from the battery 28. In other words, as the loads 30 are drawing power from the battery 42 during times when the battery 28 is providing power to the bus 14, the loads 30 can be isolated from the battery 28 by a diode 44 so that it is only the battery power for the battery 42 than drives the loads 30. Although, the battery 42 has a smaller capacity in this embodiment, in other embodiments it may be the same capacity or a larger capacity than the battery 28.

The high performance vehicle market requires short 0 to 60 mph acceleration times. This drives fuel cell vehicle electrical architectures featuring fuel cells delivering relatively low continuous power levels. Transient power needs for acceleration are covered by powerful HV batteries. The standard performance vehicle market also requires high top speeds, but slower 0-100 km/h acceleration times are accepted. A fuel cell that can cover the high continuous power demand for high top speeds can also cover the power demand for acceleration without being assisted by a high voltage battery.

This invention proposes to use a slightly bigger DC/DC converter to connect a low voltage battery and a high voltage bus and a bigger 12V battery. This way not only fuel cell system start-up is enabled. The 12V/HV converter can provide power to speed up the fuel cell air compressor, the higher airflows allow more power to be drawn from the fuel cell earlier. In addition, the 12V/HV converter could support the high voltage bus to operate high voltage vehicle auxiliaries, such as HVAC compressor, while the fuel cell goes to standby, which in turn allows fuel (hydrogen) savings. The 12V battery 28 could be recharged during vehicle deceleration, i.e., the traction motor braking the wheels and turning mechanical energy into electrical energy. Furthermore, the battery 28 could be charged at zero traction torque conditions, where the power level would be sufficient to load the fuel cell such that low efficiency operation is avoided.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a high voltage bus;
a fuel cell stack electrically coupled to the high voltage bus;
a bi-directional power matching module electrically coupled to the high voltage bus;
a first 12 volt battery electrically coupled to the power module opposite to the high voltage bus;
a second 12 volt battery electrically coupled to the first 12 battery, said second 12 volt battery being a smaller capacity battery than the first 12 volt battery;
a diode electrically coupled between the first and second 12 volt batteries and only allowing current flow from the first 12 volt battery to the second 12 volt battery; and
a plurality of 12 volt loads electrically coupled to the second 12 volt battery.

2. The fuel cell system according to claim 1 wherein the first and second 12 volt batteries are lead-acid batteries.

3. The fuel cell system according to claim 1 wherein the fuel cell system is on a vehicle.

4. The fuel cell system according to claim 1 further comprising a plurality of high voltage loads electrically coupled to the high voltage bus.

5. The fuel cell system according to claim 4 wherein the high voltage loads include an electric traction motor.

6. A fuel cell system for a vehicle comprising:
a high voltage bus;
a fuel cell stack electrically coupled to the high voltage bus;
a bi-directional power matching module electrically coupled to the high voltage bus; and
a first 12 volt lead-acid battery electrically coupled to the power module opposite to the high voltage bus.

7. The fuel cell system according to claim 6 further comprising a second 12 volt battery electrically coupled to the first 12 volt battery.

8. The fuel cell system according to claim 7 wherein the second 12 volt battery has a smaller capacity than the first 12 volt battery.

9. The fuel cell system according to claim 7 further comprising a diode electrically coupled between the first and second 12 volt batteries and only allowing current to flow from the first 12 volt battery to the second 12 volt battery.

10. The fuel cell system according to claim 7 further comprising a plurality of 12 volt loads electrically coupled to the second 12 volt battery.

11. The fuel cell system according to claim 6 further comprising a plurality of high voltage loads electrically coupled to the high voltage bus.

12. The fuel cell system according to claim 11 wherein the high voltage loads include an electric traction motor.

13. A fuel cell system for a vehicle comprising:
a high voltage bus;
a fuel cell stack electrically coupled to the high voltage bus;
a bi-directional power matching module electrically coupled to the high voltage bus;
a first 12 volt lead-acid battery electrically coupled to the power module opposite to the high voltage bus;
a second 12 volt lead-acid battery electrically coupled to the first 12 volt battery;
a diode electrically coupled between the first and second 12 volt batteries and only allowing current flow from the first 12 volt battery to the second 12 volt battery; and
a plurality of 12 volt loads electrically coupled to the second 12 volt battery.

14. The fuel cell system according to claim 13 wherein the second 12 volt battery is a smaller capacity battery than the first 12 volt battery.

15. The fuel cell system according to claim 13 further comprising a plurality of 12 volt loads electrically coupled to the second 12 volt battery.

16. The fuel cell system according to claim 13 further comprising a plurality of high voltage loads electrically coupled to the high voltage bus.

17. The fuel cell system according to claim 16 wherein the high voltage loads include an electric traction motor.
